(19) United States
(12) Patent Application Publication
(10) Pub. No.: US 2007/0008276 A1
(43) Pub. Date: Jan. 11, 2007

(54) Interface unit and interface transmission method thereof

(76) Inventor: Kuei-Ping Wang, Taipei City (TW)

Correspondence Address: RABIN & Berdo, PC, 1101 14TH STREET, NW, SUITE 500, WASHINGTON, DC, 20005, US

(21) Appl. No.: 11/400,382

(22) Filed: Apr. 10, 2006

(30) Foreign Application Priority Data
Jul. 5, 2005 (TW) 94122761

(51) Int. Cl. G09G 3/36

(52) U.S. Cl. 345/104

(57) ABSTRACT

An interface unit electrically coupled to a display module. The interface unit includes an interface controller and a pin mask. The interface controller is for receiving a first display signal and outputting a second display signal under a writing mode. The pin mask has N pins electrically coupled to the interface controller. The interface controller selectively and electrically couple M pins of the display module to the N pins according to a pin configuration mode, and outputs the second display signal to the display module for display via the N pins and the M pins.

This application claims the benefit of Taiwan application Serial No. 94122761, filed Jul. 5, 2005, the subject matter of which is incorporated herein by reference.

### BACKGROUND OF THE INVENTION

1. Field of the Invention

The invention relates in general to an interface unit and interface transmission method thereof, and more particularly to an interface unit capable of supporting several display modules and interface transmission method thereof.

2. Description of the Related Art

The liquid crystal display (LCD) is widely applied to electronic products, such as computer monitors and mobile phones. Referring to FIG. 1, a block diagram of a conventional LCD system is shown. The LCD system 100 includes a display control module 101, a frame buffer 102, a LCD module interface unit 103, and a LCD module 104.

The display control module 101 is used for generating a display signal S11 by performing a data processing and decoding process. The frame buffer 102 is for receiving the display signal S11. When the display signal S11 inputs to the frame buffer 102 and accumulates to have a frame data amount, the display signal S11 is transmitted to the LCD module interface unit 103. The LCD module interface unit 103 outputs a display signal S12 after processing the display signal S11. Meanwhile, the frame buffer 102 receives next frame data of the display signal S11, and the LCD module 104 displays the image frame according to the display signal S12.

However, due to different specifications of the LCD modules produced by various factories, the method that the LCD module interface unit transmits the display signal to the LCD module also differs as well as the data line width and pin definition of the LCD module. As a result, the present-used LCD interface unit cannot support various LCD modules. In order to solve the issue, specific LCD module interface units have to be designed to work with different LCD modules. The LCD module interface unit, which is designed by great efforts of research & development staffs, can only be applied to its specific LCD module, thereby reducing the compatibility and application scope of the LCD module interface unit. Furthermore, large cost and resources should be wasted due to frequently re-designing of the LCD module interface unit.

### SUMMARY OF THE INVENTION

It is therefore an object of the invention to provide an interface unit and interface transmission method thereof. The interface unit can support a variety of LCD module specifications and needs not to be designed again.

The invention achieves the above-identified object by providing an interface unit electrically coupled to a display module. The interface unit includes an interface controller and a pin mask. The interface controller is for receiving a first display signal and outputting a second display signal under a writing mode. The pin mask has N pins electrically coupled to the interface controller. The interface controller selectively and electrically couple M pins of the display module to the N pins according to a pin configuration mode, and outputs the second display signal to the display module for display via the N pins and the M pins.

The invention achieves the above-identified object by providing an interface transmission method applied to an interface unit. The interface unit electrically coupled to M pins of a display module via N pins. The interface transmission method includes selectively and electrically coupling the M pins to the N pins according to a pin configuration mode, wherein N and M are natural numbers; generating a second display signal according to a first display signal under a writing mode, and transmitting the second display signal to the display module via the N pins and the M pins.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a conventional LCD system. [00101 FIG. 2 is a block diagram of a display system according to a preferred embodiment of the invention.

FIG. 3 is a schematic diagram of the pin mask according to a preferred embodiment of the invention.

FIG. 4 is a flow chart of interface transmission method according to the preferred embodiment of the invention.

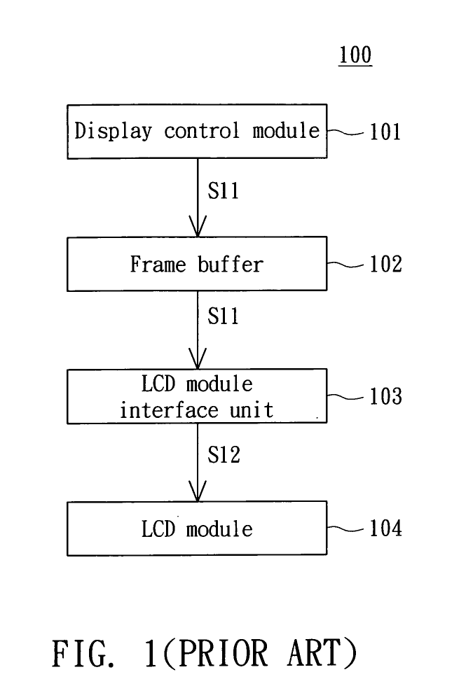

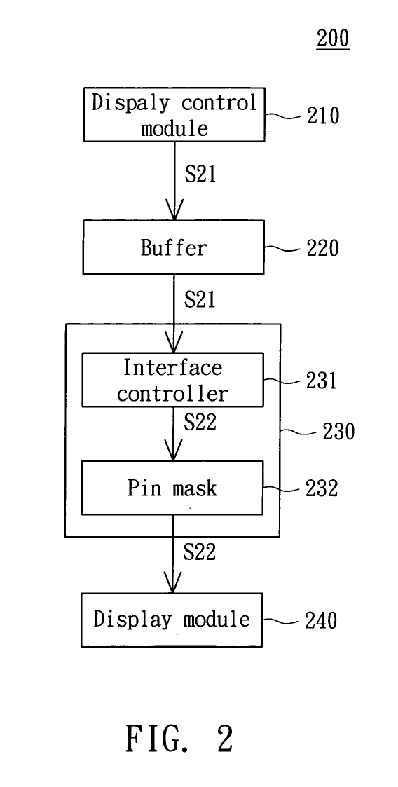

### DETAILED DESCRIPTION OF THE INVENTION

Referring to FIG. 2, a block diagram of a display system according to a preferred embodiment of the invention is shown. The display system 200 includes a display control module 210, a buffer 220, an interface unit 230 and a display module 240. The display control module 210 is for outputting a first display signal S21. The buffer 220 registers the first display signal S21 for output. The interface unit 230 generates a second display signal S22 to the display module 240 for display after receiving and processing the first display signal S21. The display module is a LCD module for instance.

The buffer 220 is a line buffer as preferred. Each time when the interface unit 230 successfully outputs the data of a pixel row of the second display signal S22, the interface unit 230 waits for the data of the next pixel row of the first display signal S1 stored into the buffer 220 to renew the original data. Then, the interface unit 230 outputs the display data of the next pixel row until the whole-frame data are outputted completely.

The interface unit 230, such as a LCD module interface unit, generates and outputs the second display signal S22 to the display module 240 under a writing mode after receiving the first display signal S21. The interface unit 230 includes an interface controller 231 and a pin mask 232. The interface controller 231 is for receiving the first display signal S21 outputted by the buffer 229 and generating the second display signal S22. The pin mask 232 has N pins electrically coupled to the interface controller 231. The display module 240 has M pins electrically coupled to the pin mask 232 for receiving the second display signal S22.

The interface controller 231, under a pin configuration mode, controls the M pins of the display module 240 to be selectively and electrically coupled to the N pins of the pin mask 232, and thus the second display signal S22 can be outputted to the display module 240 for display via the N pins and the M pins. N and M are natural numbers. The writing mode and pin configuration mode mentioned above are determined according to the specification of the display module 240.

The interface unit 230 selects the corresponding writing mode according to the specification of the display module 240. The second display signal S22 is a RGB signal for instance. In the embodiment, the display module 240 can have a specification, such as RGB-666, RGB-565, (RG-63, GB-36), (RG-53, GB35) and (R6, G6, B6) and so on. In accordance with the above-mentioned specifications, the method by which the interface unit 230 writes data into the display module 240 in the embodiment can be divided into three modes.

In the first writing mode, such as RGB-666, RGB-565, data of a pixel are written in a one-time-writing process. In the second writing mode, such as (RG-63, GR-36), (RG-53, GB35), data of a pixel are written in a two-time-writing process. In the third writing mode, such as (R6, G6, B6), the data of a pixel are written in a three-time-writing process.

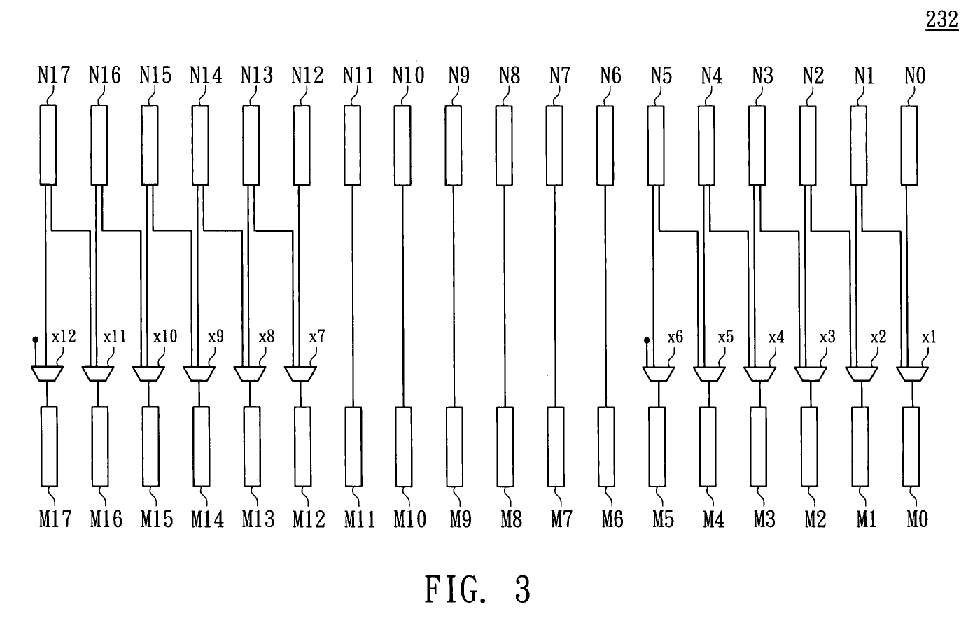

The pin mask 232 can solve the issue of different data line width and pin definition in connection of the interface unit 230 and the display module 240. Referring to FIG. 3, a schematic diagram of the pin mask according to a preferred embodiment of the invention is shown. In FIG. 3, the interface unit 230 is exemplified to be capable of support the specification RGB-666 or RGB-565 of the display module 240. RGB-666 represents red, green, and blue pixel signals are respectively transmitted via 6 pins. RGB-565 represents red and blue pixel signals are transmitted via 5 pins while the green pixel signals are transmitted via 6 pins.

The pin mask 232 includes pins N0˜N17 for electrically coupling to the interface controller 231. The pins M0˜M17 are possible pins of the display module 240. In accordance with the specification, the pin configuration mode is determined how the pins M0˜-M17 of the display module 240 are electrically coupled to the pins N0˜N17. For example, the pins N0˜N5 are for transmitting blue pixel signals, the pins N6˜N11 are for transmitting green pixel signals, and the pins N12˜N17 are for transmitting red pixel signals.

The pin mask 232 includes multiplexers X1˜X12 for determining how to couple the pins M0˜M17 with the pins N0˜N17. The interface controller 231 controls the multiplexers X1˜X12 to selectively and electrically couple the pins M0˜M17 of the display module 240 to the pins N0˜N17 of the pin mask 232. If the writing method of the display module 240 is RGB-666, the multiplexer X1˜X12 electrically couples the pins M0˜M5 and M12˜M17 to the pin N0˜N5 and N12˜N17 respectively.

Besides, the pins M6˜M11 are electrically coupled to the pins N6˜N11 respectively no matter the display module 240 has the specification RGB-666 or RGB 565.

If the writing method of the display module 240 is RGB-565, the multiplexers X1˜X5 electrically couples the pins M0˜M4 to the pins N1˜N5 respectively, the multiplexers X7˜X11 electrically couples the pins M12˜M16 to the pins N13˜N17 respectively, while the multiplexers X6 and X12 make the pins M5 and M17 open.

In order to include other types of specifications that the interface unit 230 can support, such as (RG-63, GB-36), (RG-53, GB35), and (R6, G6, B6) and so on, the types of the method that the interface controller 231 writes the second display signal S22 into the display module 240 can be increased. In the pin mask 232, the number of multiplexers are increased accordingly to provide more electrical coupling relations between the pins M0˜M17 and the pins N0˜N17. As for how the pins M0˜M17 are coupled to the pins N0˜N17, it depends on the pin configuration mode determined by the display module 240. In this way, the interface unit 230 can support the display modules 240 of different specifications. The number of the pins N0˜N17 of the pin mask 232 is not smaller than the maximum number of pins of the display module 240, that is, N is not smaller than M.

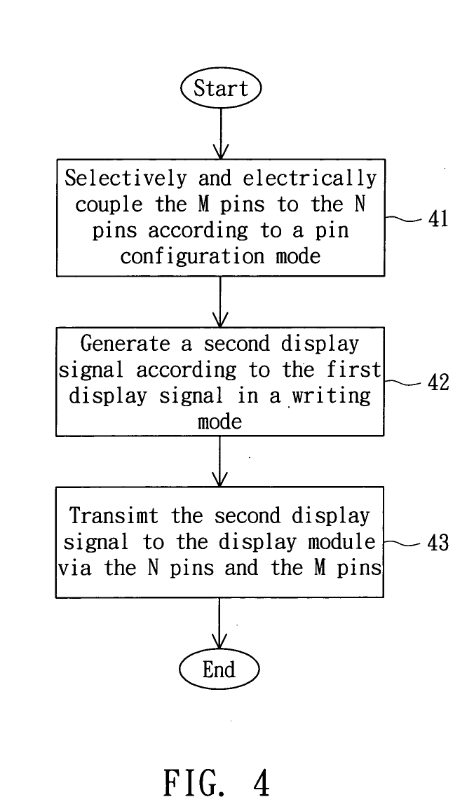

Referring to FIG. 4, a flow chart of interface transmission method according to the preferred embodiment of the invention is shown. First, in step 41, selectively and electrically couple the M pins to the N pins according to the pins configuration mode, wherein N and M are natural numbers. Next, in step 42, generate a second display signal S22 according to a first display signal S21 under a writing mode. Afterward, in step 43, transmit the second display signal S22 to the display module 240 via the N pins and the M pins.

The interface unit and interface transmission method disclosed by the above-mentioned embodiment of the invention can prevent the issue that the writing method and pin definition of the interface unit has to be repeatedly designed to support different display module. Therefore, the compatibility of the interface unit can be improved and the cost and resources for designing the interface unit repeatedly can be saved. Furthermore, in the invention, the purpose of reducing hardware cost can be achieved by using the line buffer to decrease the size of the buffer.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An interface unit, electrically coupled to a display module, the interface unit comprising:
an interface controller, for receiving a first display signal, and outputting a second display signal under a writing mode; and
a pin mask, having N pins electrically coupled to the interface controller, wherein the interface controller selectively and electrically couple M pins of the display module to the N pins according to a pin configuration mode, and outputs the second display signal to the display module for display via the N pins and the M pins, wherein N and M are natural numbers.

2. The interface unit according to claim 1, wherein the display module is a liquid crystal display (LCD) module.

3. The interface unit according to claim 1, wherein the writing mode comprises:
a first writing mode, for writing data of a pixel in a one-time-writing process;
a second writing mode, for writing data of a pixel in a two-time-writing process; and
a third writing mode, for writing data of a pixel in a three-time-writing process.

4. The interface unit according to claim 1, wherein the second display signal is a RGB signal.

5. The interface unit according to claim 1, wherein the pin mask has a plurality of multiplexers and the interface unit controls the multiplexers to selectively and electrically couple the M pins to the N pins according to the pin configuration mode.

6. The interface unit according to claim 1, wherein the number N is not smaller than M.

7. The interface unit according to claim 1, wherein the writing mode and the pin configuration mode are determined by the display module.

8. An interface transmission method, applied to an interface unit, the interface unit electrically coupled to M pins of a display module via N pins, the interface transmission method comprising:
selectively and electrically coupling the M pins to the N pins according to a pin configuration mode, wherein N and M are natural numbers;
generating a second display signal according to a first display signal under a writing mode, and
transmitting the second display signal to the display module via the N pins and the M pins.

9. The interface transmission method according to claim 8, wherein the display module is a LCD module.

10. The interface transmission method according to claim 8, wherein the writing mode comprises:
a first writing mode, for writing data of a pixel in a one-time-writing process;
a second writing mode, for writing data of a pixel in a two-time-writing process, and
a third writing mode, for writing data of a pixel in a three-time-writing process.

11. The interface transmission method according to claim 8, wherein the second display signal is a RGB signal.

12. The interface transmission method according to claim 8, wherein the interface unit has a plurality of multiplexers and controls the multiplexers to selectively and electrically couple the M pins to the N pins according to the pin configuration mode.

13. The interface transmission method according to claim 8, wherein the number N is not smaller than M.

14. The interface transmission method according to claim 8, wherein the writing mode and the pin configuration mode are determined according to specification of the display module.

15. A display system, comprising:
a display control module, for outputting a first display signal;
a buffer, for registering and outputting the first display signal;
an interface unit, comprising:
an interface controller, for receiving the first display signal outputted by the buffer and outputting a second display signal under a writing mode; and
a pin mask, having N pins for electrically coupling to the interface controller; and
a display module, comprising M pins for electrically coupling to the pin mask, wherein the interface controller selectively and electrically couples the M pins to the N pins according to a pin configuration mode, and outputs the second display signal to the display module for display via the N pins and the M pins, wherein N and M are natural numbers.

16. The display system according to claim 15, wherein the display module is a LCD display module and the second display signal is a RGB signal.

17. The display system according to claim 15, wherein the writing mode comprises:
a first writing mode, for writing data of a pixel in a one-time-writing process;
a second writing mode, for writing data of a pixel in a two-time-writing process; and
a third writing mode, for writing data of a pixel in a three-time-writing process.

18. The display system according to claim 15, wherein the pin mask has a plurality of multiplexers and the interface unit controls the multiplexers to selectively and electrically couple the M pins to the N pins according to the pin configuration mode.

19. The display system according to claim 15, wherein the number N is not smaller than M.

20. The display system according to claim 15, wherein the writing mode and the pin configuration mode are determined according to specification of the display module.
